(19) United States
(12) Patent Application Publication
(10) Pub. No.: US 2013/0214607 A1
(43) Pub. Date: Aug. 22, 2013

(54) ELECTROMAGNETIC INTERFERENCE CANCELLING DURING POWER CONVERSION

(71) Applicant: Michael John Harrison, Petaluma, CA (US)

(72) Inventor: Michael John Harrison, Petaluma, CA (US)

(73) Assignee: ENPHASE ENERGY, INC., Petaluma, CA (US)

(21) Appl. No.: 13/398,981

(22) Filed: Feb. 17, 2012

(51) Int. Cl. H02J 1/00; H02M 3/335

(52) U.S. Cl. 307/82; 307/43; 363/20

(57) ABSTRACT

Apparatus for cancelling electromagnetic interference (EMI) during power conversion. In one embodiment, the apparatus comprises a power converter for converting a DC input to a DC output, wherein the power converter comprises a transformer having a primary winding and a secondary winding, the secondary winding coupled to a diode such that a plurality of secondary winding voltages cause a balanced current flow through a plurality of parasitic capacitances.

### BACKGROUND OF THE INVENTION

1. Field of the Invention

Embodiments of the present disclosure relate generally to power conversion, and, in particular, to cancelling electromagnetic interference during power conversion.

2. Description of the Related Art

Power converters are widely used in many applications, such as renewable energy generation. Flyback converters are one type of switched mode power converter that converts DC input power to DC output power utilizing a transformer to provide galvanic isolation between the converter input and output. As a result of parasitic capacitance that links the transformer's primary and secondary windings, known as inter-winding capacitance, common mode current can flow between the windings and result in harmful common mode noise (CMN) and electromagnetic interference (EMI) that can lead to performance degradation of other electronic equipment.

In order to be commercially sold, switched mode power converters such as flyback converters must meet relevant regulatory requirements which limit the EMI that can be produced.

Therefore, there is a need in the art for apparatus for eliminating EMI during power conversion.

### SUMMARY OF THE INVENTION

Embodiments of the present invention generally relate to apparatus for cancelling electromagnetic interference (EMI). In one embodiment, the apparatus comprises a power converter for converting a DC input to a DC output, wherein the power converter comprises a transformer having a primary winding and a secondary winding, the secondary winding coupled to a diode such that a plurality of secondary winding voltages cause a balanced current flow through a plurality of parasitic capacitances.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a power conversion system in accordance with one or more embodiments of the present invention;

FIG. 2 is a plurality of graphs depicting current and voltage waveforms of the DC-DC converter in accordance with one or more embodiments of the present invention; and

FIG. 3 is a block diagram of a system for power conversion using one or more embodiments of the present invention.

### DETAILED DESCRIPTION

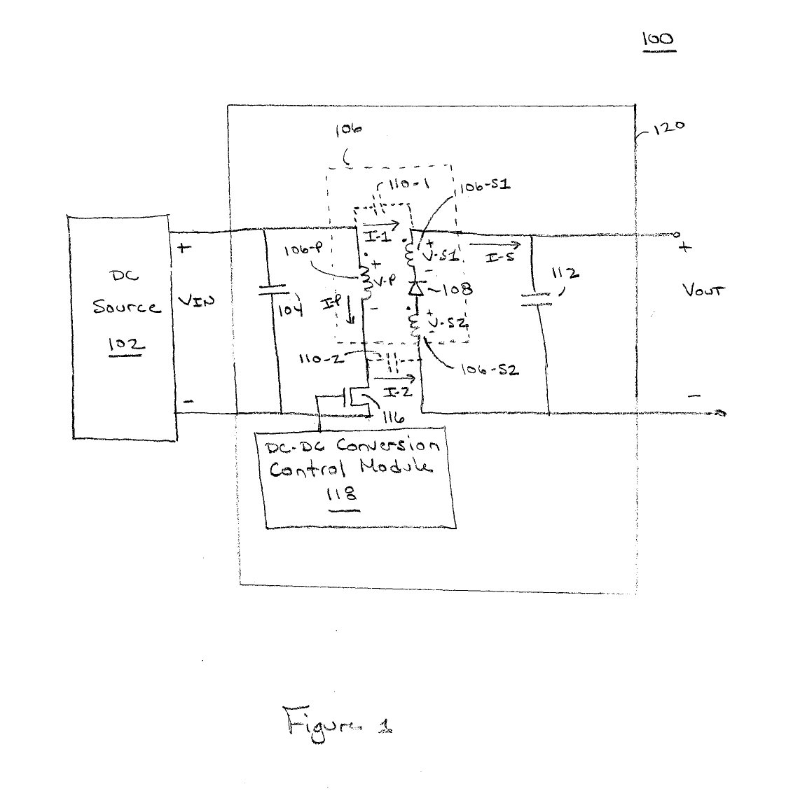

FIG. 1 is a block diagram of a power conversion system 100 in accordance with one or more embodiments of the present invention. The power conversion system 100 comprises a DC source 102 and a DC-DC converter 120. The DC source 102 may be any suitable DC source, such as an output from a preceding power conversion stage, a battery, a renewable energy source (e.g., a solar panel or photovoltaic (PV) module, a wind turbine, a hydroelectric system, or similar renewable energy source), or the like, for providing a DC voltage.

The DC-DC converter 120 may be employed in a stand-alone configuration for DC-DC power conversion as depicted in FIG. 1. Alternatively, the DC-DC converter 120 may be utilized with or as a component of other power conversion devices, such as a DC-AC inverter. For example, the DC-DC converter 120 may be a DC-DC power conversion stage within a DC-AC inverter that converts DC power from the DC source 102 to AC power.

The DC-DC converter 120 is a flyback converter that converts a DC input voltage Vin to a DC output voltage Vout. The DC-DC converter 120 comprises an input capacitor 104, a transformer 106 having a primary winding 106-P and a secondary winding 106-S, a current control switch 116, a diode 108, an output capacitor 112, and a DC-DC conversion control module 118. A primary side of the DC-DC converter 120 comprises the input capacitor 104 coupled across the DC source 102 for receiving the input voltage Vin. The input capacitor 104 is also coupled across a series combination of the primary winding 106-P and the current control switch 116; i.e., a first terminal of the primary winding 106-P is coupled to a first terminal of the input capacitor 104, a second terminal of the primary winding 106-P is coupled to a first terminal of the current control switch 116, and a second terminal of the current control switch 116 is coupled to a second terminal of the input capacitor 104. In some embodiments, the current control switch 116 may be an n-type metal-oxide-semiconductor field-effect transistor (MOSFET) where the first terminal is a drain terminal and the second terminal is a source terminal. In other embodiments, the current control switch 116 may be a different type of electronic switch, such as a p-type MOSFET, an insulated gate bipolar transistor (IGBT), a gate turn-off (GTO) switch, a bipolar junction transistor (BJT), or the like, or some combination thereof.

The DC-DC conversion control module 118 is coupled to the current control switch 116 for operably controlling (i.e., activating and deactivating) the current control switch 116.

On a secondary side of the DC-DC converter 120, the diode 108 divides the secondary winding 106-S into a first secondary winding 106-S1 and a second secondary winding 106-S2, where the first secondary winding 106-S1 and the second secondary winding 106-S2 have equal number of turns. A first terminal of the output capacitor 112 is coupled to a first terminal of the first secondary winding 106-S1, and a second terminal of the output capacitor 112 is coupled to a second terminal of the second secondary winding 106-S2. The diode 108 is coupled between the first and second secondary windings 106-S1 and 106-S2 such that a cathode terminal of the diode 108 is coupled to a second terminal of the first secondary winding 106-S1 and an anode terminal of the diode 108 is coupled to a first terminal of the second secondary winding 106-S2. The first and second terminals of the output capacitor 112 are coupled across positive and negative output terminals, respectively, of the DC-DC converter 120.

The transformer 106 has a turns ratio of Ns/Np, where Ns is the number of turns in the secondary winding 106-S (i.e., the number of turns in 106-S1 and 106-S2), and Np is the number of turns in the primary winding 106-P. In some embodiments, the transformer 106 may be a step-up transformer; in other embodiments, the transformer 106 may be a step-down transformer. The transformer turn ratio may generally be between 20:1 and 1:20, but larger numbers are possible. The capacitors 104 and 112 generally each have capacitances on the order of one microfarad (pF) to several tens of thousands microfarads, although one or both capacitances may higher or lower

As a result of parasitic capacitance of the transformer 106, inter-winding capacitances electrically couple the primary winding 106-P to the secondary windings 106-S1 and 106-S2. A first inter-winding capacitance is represented as inter-winding capacitor 110-1 coupled between the first terminals of the primary winding 106-P and the first secondary winding 106-S1, and a second inter-winding capacitance is represented as inter-winding capacitor 110-2 coupled between the second terminals of the primary winding 106-P and the second secondary winding 106-S2. The inter-winding capacitances may range from 10 picofarads (pF) to several hundred picofarads.

In operation, the DC-DC converter 120 receives the DC input voltage Vin from the DC source 102 and converts the DC input voltage Vin to the DC output voltage Vout based on the activation/deactivation of the current control switch 116 as driven by the DC-DC conversion control module 118. Generally, the switching frequency of the current control switch 116 is in the range of a few kilohertz (kHz) to several hundred kilohertz. When the current control switch 116 is activated (i.e., closed), a linearly rising primary winding current I-P flows through the primary winding 106-P, storing energy within the primary winding 106-P. When the primary winding current I-P reaches a level sufficient to generate the desired output voltage Vout, the current control switch 116 is deactivated (i.e., opened), causing the energy stored in the primary winding 106-P to be transferred to the first and second secondary windings 106-S1/106-S2 and generating a secondary winding current I-S through the first and second secondary windings 106-S1/106-S2. The resulting charging/discharging of the output capacitor 112 over the current control switch switching cycles results in the output voltage Vout.

In accordance with one or more embodiments of the present invention, voltages V-S1 and V-S2 generated across the first and second secondary windings 106-S1 and 106-S2, respectively, during operation of the DC-DC converter 120 result in a balanced current flow through the inter-winding capacitors 110-1 and 110-2—i.e., equal and opposite currents flow through the parasitic capacitances—thereby cancelling electromagnetic interference (EMI) that would otherwise result from common mode current flowing unbalanced through the inter-winding capacitors 110-1 and 110-2.

In some other embodiments, the DC-DC converter 120 may be any type of switched mode power supply, such as a buck, boost, forward, single ended primary inductance converter (SEPIC), Cuk, Zeta, push-pull, and the like. Additionally, the invention described herein may be applied to all derivatives of switched mode power supply topologies, such as hard switched, zero-voltage transition (ZVT) soft switched, zero- current transition (ZCT) soft switched, series resonant, parallel resonant, quasi resonant, and the like.

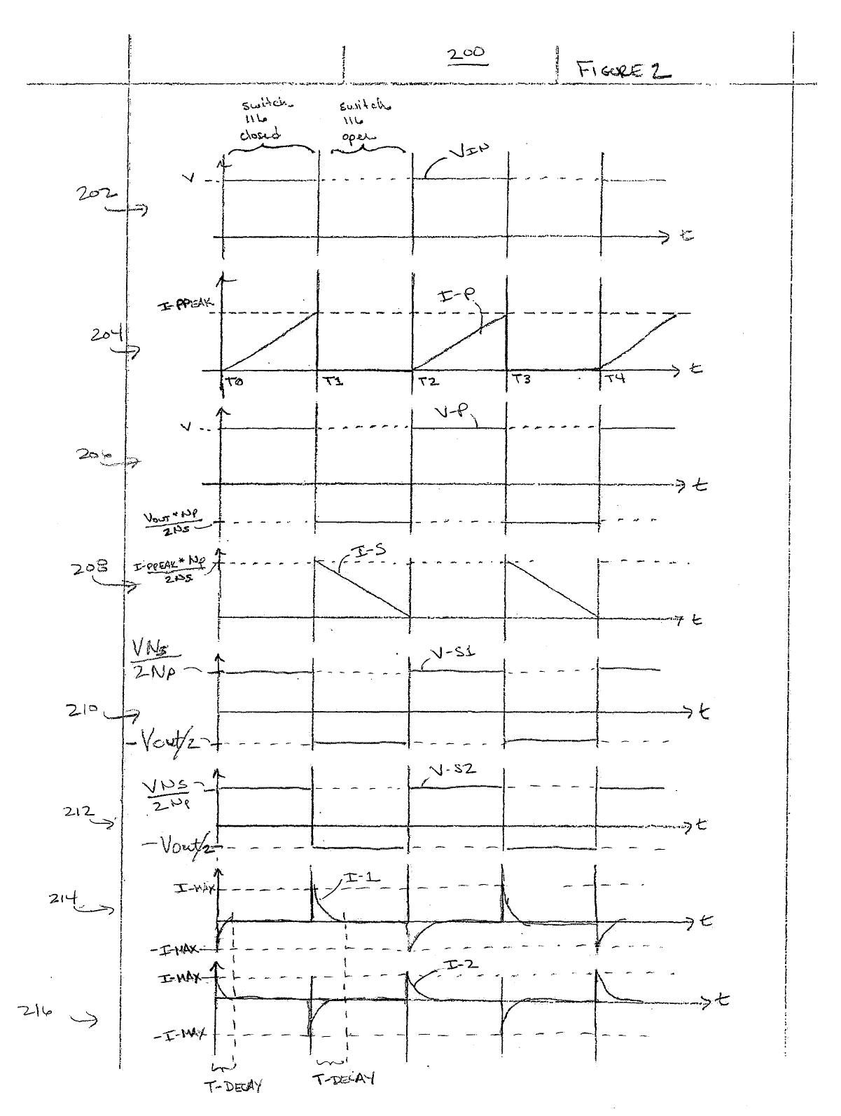

FIG. 2 is a series of graphs 200 depicting current and voltage waveforms of the DC-DC converter 120 in accordance with one or more embodiments of the present invention. The series of graphs 200 comprises graph 202 depicting the level of input voltage Vin over time; graph 204 depicting the level of primary winding current I-P over time; graph 206 depicting the level of a voltage V-P across the primary winding 106 over time; graph 208 depicting the level of secondary winding current I-S through the secondary winding 106-S over time; graph 210 depicting the level of a first secondary winding voltage V-S1 across the first secondary winding 106-S1 over time; graph 212 depicting the level of a second secondary winding voltage V-S2 across the second secondary winding 106-S2 over time; graph 214 depicting the level of a first inter-winding current I-1 through the inter-winding capacitor 110-1 over time; and graph 216 depicting the level of a second inter-winding current I-2 through the second inter-winding capacitor 110-2 over time.

At time T0, the current control switch 116 is closed. The input voltage Vin and the primary winding voltage V-P are each at a level V and remain at the level V through time T1. The primary winding current I-P begins to linearly rise from a value of zero and reaches a peak value I-PPEAK at time T1. On the secondary side, the secondary winding current I-S is zero at time T0 and remains zero through time T1. The first secondary winding voltage V-S1 and the second secondary winding voltage V-S2 are each at a value (Ns/Np)*(V/2). Equal but opposite currents flow through the first and second inter-winding capacitors 110-1 and 110-2; at time T0 the first and second inter-winding currents I-1 and I-2 have values of I-MAX and −(I-MAX), respectfully, and subsequently decay exponentially to reach zero at a time T-DECAY after T0. The decay time T-DECAY is generally on the order of 10 nanoseconds (ns) to a few hundred nanoseconds, although in some embodiments it may be shorter or longer. The inter-winding currents I-1 and I-2 then remain at zero through T1.

The peak magnitude I-MAX of the inter-winding currents I-1 and I-2 generally depends upon the physical layout of the DC-DC converter 120. In some embodiments, the peak magnitude I-MAX may range from many milliamps (mA) to a few amps (A).

At time T1, the current control switch 116 is opened. The input voltage Vin and the primary winding current I-P drop to zero and remain at zero though time T2. The primary winding voltage V-P reverses to a value of (Vout/2)*(Np/Ns). On the secondary side, the secondary winding current I-S begins to flow at a level of (Ippeak/2)*(Np/Ns) and linearly decays to zero, reaching zero at time T2. The first and second secondary winding voltages V-S1 and V-S2 each reverse to a value −(Vout/2). Equal but opposite currents again flow through the first and second inter-winding capacitors 110-1 and 110-2; at time T1 the first and second inter-winding currents I-1 and I-2 have values of −(I-MAX) and I-MAX, respectively, and subsequently decay exponentially to reach zero at a time T-DECAY after T1. The inter-winding currents I-1 and I-2 then remain at zero through T2.

At time T2, the current control switch 116 is once again opened and remains open through time T3. The primary side and secondary side voltages and currents operate as previously described for the time period T0 to T1.

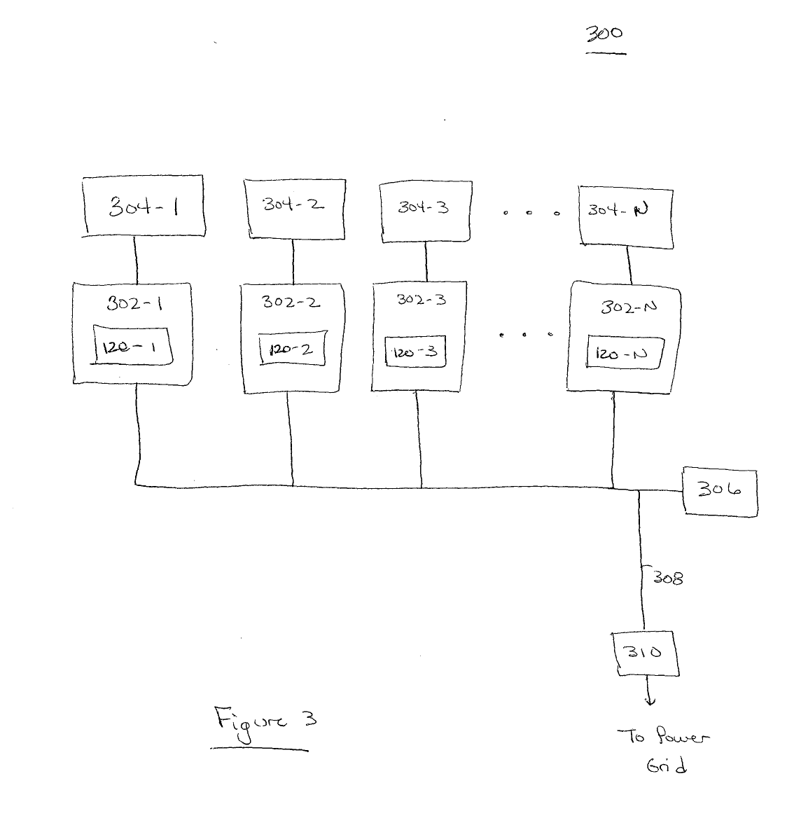

FIG. 3 is a block diagram of a system 300 for power conversion using one or more embodiments of the present invention. This diagram only portrays one variation of the myriad of possible system configurations and devices that may utilize the present invention. The present invention can be utilized in any system or device requiring a switched mode converter for converting a first DC power to a second DC power, such as a DC-DC converter, a DC-AC converter, or the like. The switched mode converter may be any type of switched mode power supply, such as a flyback, buck, boost, forward, single ended primary inductance converter (SEPIC), Cuk, Zeta, push-pull, and the like. Additionally, the invention described herein may be applied to all derivatives of switched mode power supply topologies, such as hard switched, zero-voltage transition (ZVT) soft switched, zero-current transition (ZCT) soft switched, series resonant, parallel resonant, quasi resonant, and the like.

The system 300 comprises a plurality of DC-AC inverters 302-1, 302-2, 302-3 . . . 302-N, collectively referred to as inverters 302; a plurality of DC power sources 304-1, 304-2, 304-3 . . . 304-N, collectively referred to as DC power sources 304; a controller 306; an AC bus 308; and a load center 310. The DC power sources 304 may be any suitable DC source, such as an output from a previous power conversion stage, a battery, a renewable energy source (e.g., a solar panel or photovoltaic (PV) module, a wind turbine, a hydroelectric system, or similar renewable energy source), or the like, for providing DC power.

Each inverter 302-1, 302-2, 302-3 . . . 302-N is coupled to a DC power source 304-1, 304-2, 304-3 . . . 304-N, respectively; in some alternative embodiments, multiple DC power sources 304 may be coupled to a single inverter 302. The inverters 302 are coupled to the controller 306 via the AC bus 308. The controller 306 is capable of communicating with the inverters 302 by wireless and/or wired communication for providing operative control of the inverters 302. The inverters 302 are further coupled to the load center 310 via the AC bus 308.

The inverters 302 convert the DC power from the DC power sources 304 to AC power that is commercial power grid compliant and couple the AC power to the load center 310. The generated AC power may be further coupled from the load center 310 to the one or more appliances and/or to a commercial power grid. Additionally or alternatively, generated energy may be stored for later use; for example, the generated energy may be stored utilizing batteries, heated water, hydro pumping, H₂O-to-hydrogen conversion, or the like.

Each of the inverters 302 comprises a DC-DC converter 120 (i.e., the inverters 302-1, 302-2, 302-3 . . . 302-N comprise the integrated DC-DC converters 120-1, 120-2, 120-3 . . . 120-N, respectively) utilized in the conversion of the DC power to AC power. The DC-DC converters 120 operate as previously described to convert a first DC power to a second DC power (i.e., the DC-DC converter 120 is a DC-DC power conversion stage of the inverter 302) and enable a balanced current flow through the inter-winding capacitances of the converter's transformer, thereby cancelling electromagnetic interference (EMI) that would otherwise result from common mode current flowing unbalanced through the inter-winding capacitances. The DC power generated by the DC-DC converter 120 is inverted to AC output power by a DC-AC conversion stage within the inverter 302.

In some alternative embodiments, the system 300 may be comprised of DC-DC converters 120, rather than DC-AC inverters, for converting the received DC power from the DC power sources 304 to a DC output power that is then coupled to a DC bus for storage (e.g., using batteries, heated water, hydro pumping, H₂O-to-hydrogen conversion, or the like) and/or immediate use (e.g., to power DC devices).

The foregoing description of embodiments of the invention comprises a number of elements, devices, circuits and/or assemblies that perform various functions as described. These elements, devices, circuits, and/or assemblies are exemplary implementations of means for performing their respectively described functions.

While the foregoing is directed to embodiments of the present invention, other and further embodiments of the invention may be devised without departing from the basic scope thereof, and the scope thereof is determined by the claims that follow.

1. Apparatus for cancelling electromagnetic interference (EMI) during power conversion, comprising:
a power converter for converting a DC input to a DC output, wherein the power converter comprises a transformer having a primary winding and a secondary winding, the secondary winding coupled to a diode such that a plurality of secondary winding voltages cause a balanced current flow through a plurality of parasitic capacitances.

2. The apparatus of claim 1, wherein the diode evenly divides the secondary winding into a first secondary winding and a second secondary winding.

3. The apparatus of claim 1, wherein the plurality of parasitic capacitances comprises a first inter-winding capacitance between the primary winding and a first secondary winding and a second inter-winding capacitance between the primary winding and a second secondary winding, wherein the secondary winding comprises the first secondary winding and the second secondary winding.

4. The apparatus of claim 3, wherein a first current flows through the first inter-winding capacitance and a second current flows through the second inter-winding capacitance, and wherein the first and the second currents have equal magnitude and opposite direction.

5. The apparatus of claim 1, wherein (i) a first terminal of a first secondary winding is coupled to a positive output terminal of the power converter, (ii) a second terminal of the first secondary winding is coupled to a cathode terminal of the diode, (iii) an anode terminal of the diode is coupled to a first terminal of a second secondary winding, and (iv) a second terminal of the second secondary winding is coupled to an output terminal of the power converter, wherein the secondary winding comprises the first secondary winding and the second secondary winding.

6. An inverter for cancelling electromagnetic interference (EMI) during power conversion, comprising:
a DC-DC power conversion stage comprising a power converter for converting a DC input to a DC output, wherein the power converter comprises a transformer having a primary winding and a secondary winding, the secondary winding coupled to a diode such that a plurality of secondary winding voltages cause a balanced current flow through a plurality of parasitic capacitances; and
a DC-AC power conversion stage for converting the DC output to an AC output.

7. The inverter of claim 6, wherein the diode evenly divides the secondary winding into a first secondary winding and a second secondary winding.

8. The inverter of claim 6, wherein the plurality of parasitic capacitances comprises a first inter-winding capacitance between the primary winding and a first secondary winding and a second inter-winding capacitance between the primary winding and a second secondary winding, wherein the secondary winding comprises the first secondary winding and the second secondary winding.

9. The inverter of claim 8, wherein a first current flows through the first inter-winding capacitance and a second current flows through the second inter-winding capacitance, wherein the first and the second currents have equal magnitude and opposite direction.

10. The inverter of claim 7, wherein (i) a first terminal of the first secondary winding is coupled to a positive output terminal of the power converter, (ii) a second terminal of the first secondary winding is coupled to a cathode terminal of the diode, (iii) an anode terminal of the diode is coupled to a first terminal of the second secondary winding, and (iv) a second terminal of the second secondary winding is coupled to an output terminal of the power converter.

11. A system for cancelling electromagnetic interference (EMI) during power conversion, comprising:
a plurality of DC power sources; and
a plurality of power modules, coupled to the plurality of the DC power sources, wherein each power module of the plurality of power modules comprises a power converter for converting a DC input to a DC output, and wherein the power converter comprises a transformer having a primary winding and a secondary winding, the secondary winding coupled to a diode such that a plurality of secondary winding voltages cause a balanced current flow through a plurality of parasitic capacitances.

12. The system of claim 11, wherein the diode evenly divides the secondary winding into a first secondary winding and a second secondary winding.

13. The system of claim 11, wherein the plurality of parasitic capacitances comprises a first inter-winding capacitance between the primary winding and a first secondary winding and a second inter-winding capacitance between the primary winding and a second secondary winding, wherein the secondary winding comprises the first secondary winding and the second secondary winding.

14. The system of claim 13, wherein a first current flows through the first inter-winding capacitance and a second current flows through the second inter-winding capacitance, wherein the first and the second currents have equal magnitude and opposite direction.

15. The system of claim 12, wherein (i) a first terminal of the first secondary winding is coupled to a positive output terminal of the power converter, (ii) a second terminal of the first secondary winding is coupled to a cathode terminal of the diode, (iii) an anode terminal of the diode is coupled to a first terminal of the second secondary winding, and (iv) a second terminal of the second secondary winding is coupled to an output terminal of the power converter.

16. The system of claim 11, wherein each DC power source in the plurality of DC power sources is coupled to a different power module of the plurality of power modules.

17. The system of claim 11, wherein the DC power sources are renewable energy sources.

18. The system of claim 17, wherein the DC power sources are photovoltaic (PV) modules.

19. The system of claim 11, wherein the power modules are DC-DC converters.

20. The system of claim 11, wherein the power modules are DC-AC inverters.
